(19) United States
(12) Patent Application Publication
(10) Pub. No.: US 2002/0059357 A1
(43) Pub. Date: May 16, 2002

(54) System, method and apparatus of simplifying interpretation of suspend and wake-up functions in operating system for information appliance (IA)

(75) Inventors: Chao-Hsien Ho, Taipei (TW); Fu-An Chuang, Taipei (TW)

Correspondence Address: BACON & THOMAS, PLLC, 625 SLATERS LANE, FOURTH FLOOR, ALEXANDRIA, VA, 22314

(73) Assignee: PAC Interactive Technology, Inc, Taipei (TW)

(21) Appl. No.: 09/938,605

(22) Filed: Aug. 27, 2001

(30) Foreign Application Priority Data
Oct. 27, 2000 (TW) 89122611

(51) Int. Cl. G06F 15/177; G06F 9/445; G06F 9/24; G06F 9/00

(52) U.S. Cl. 709/102; 713/2

(57) ABSTRACT

A system, method and apparatus for simplifying the interpretation of suspend and wake-up functions in an operating system for information appliance is disclosed. An input device integrates the suspend and wake-up functions into the same key, and a communication signal receiver accepts the signal from the input device.

The key maps for the input device are classifed into two categories, one to make the operating system to judge the system of the information appliance under a suspend status and the other to make the operating system to judge the information appliance under a non-suspend status. If the information appliance is under the suspend status, the operating system evokes a wake-up process. If the information appliance is under the non-suspend status, the operating system evokes a suspend process and sets the receiver to only accept the signal from the input device.

Claims priority of R.O.C. (Taiwan) Patent invention application serial No. 89122611 filed Oct. 27, 2000.

### FIELD OF THE INVENTION

The present invention relates generally to the field of simplifying the interpretation of the suspend and wake-up processes in the operating system (OS) for information appliance (IA).

### BACKGROUND OF THE INVENTION

In the post-PC (Personal Computer) era of the Information Technology (IT) an important trend is towards the so-called “information appliance” (IA) that combines personal computers and conventional appliances. This booming industry basically relates to the technologies of IT and IA as well as the industry of PC and conventional appliance.

In relevant products of IT or PC, their operations are performed via input peripherals such as key boards, mouses and track balls, etc. These input peripherals and their operating processes are complicated. For instance, in FIG. 1, the stand-by (suspend) function for a PC is performed by pressing one key on the key board to evoke the control function (1A), while with another key on the key board pressed the system will become waken-up (1B). Both the keys are interpreted via distinct key maps to get different interpreting signals (shown in blocks 1A1 and 1B1). Then the signals are transferred via the basic input/output system (BIOS) to the operating system (OS) to evoke respective suspend or wake-up function.

As mentioned above, the conventional keyboard or remote controller needs two distinct keys for the suspend and wake-up functions, respectively however, users of traditional appliances may not get used to using two different keys, as computer users do, to obtain the suspend and wake-up functions. In view of the problems the present invention is aimed to make the interface of IA more hominized, friendly and popular, such that users of traditional appliances do not need to change their habits in using these keys.

### SUMMARY OF THE INVENTION

The invention applies an integrated key to operate the spspend and wake-up functions, so as to make the interface of IA more hominized, friendly and simplified. Also, the invention replaces the shutting down of computer with the suspend function to avoid the tedious boot process for operation convenience, saving energy, promoting the stability and reliability of IA which applies the firmware on the communication signal control chip to load the possible key maps for respective remote controller, remote control keyboard or panel of IA such that the signals received from the integrated key. The invention combines the suspend and wake-up functions, on the remote controller, remote control keyboard or the panel of IA, can be interpreted via the key maps stored on the firmware to be recognizable to OS and thus evoke the suspend or wake-up function.

The invention solves the conventional problems of inconvenience, high error rate and low reliability caused by using two distinct keys for the suspend and wake-up functions, respectively.

The invention makes the information appliance more convenient, hominized, friendly and reliable.

The invention also presents a method of constructing and operating said information appliance system that merges the suspend and wake-up function into the same key.

The hardware of the invention comprises: an input device, which merges the suspend and wake-up functions into the same key; a communication signal receiver; a communication signal control chip; a main control circuit board; and a hard disc.

The software of the invention comprises: a firmware, which has the key maps; a BIOS; and an OS, which has a shell program.

The advantages of the present invention reside in the simplification of the interpretation of OS, and the integration of suspend and wake-up functions into the same key on the remote controller, remote control keyboard or panel of IA to avoid the mis-pressing of function keys, while promoting the convenience of end users and raising the system reliability. Particularly, the users of traditional appliance can hold their operating habits for information appliances.

### BRIEF DESCRIPTION OF THE DRAWINGS

FIG. 1 is the operation schema of prior art;

FIG. 2 is the operation schema according to the present invention;

FIG. 3 is the software operation schema according to the present invention;

FIG. 4 is the flowchart diagram of the system operation of the present invention; and

FIG. 5 is the flowchart diagram of the software procedure of the invention.

### DETAILED DESCRIPTION OF THE EMBODIMENTS

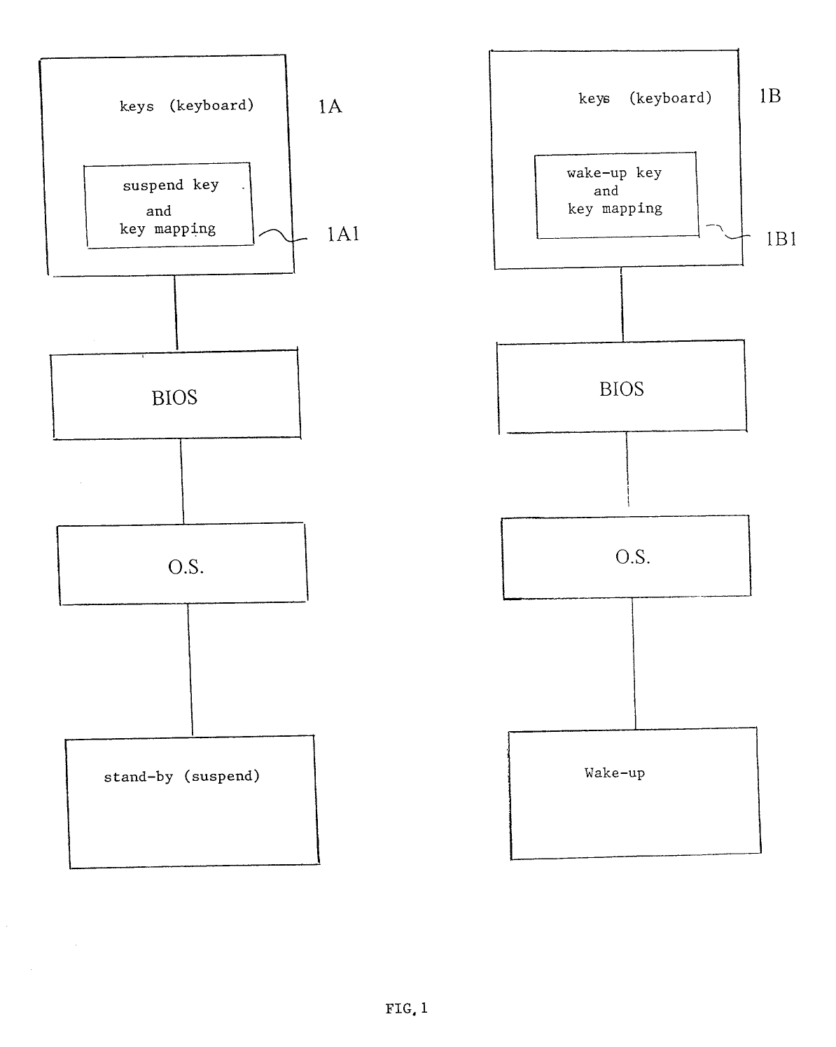

There are various types of remote controllers, remote control keyboards and panels in prior arts, which have different press-key layouts and distinct coded key maps for the suspend and wake-up functions. A typical example is shown in FIG. 1 with block 1A as the operation of the suspend function and block 1B as the operation of the wake-up function.

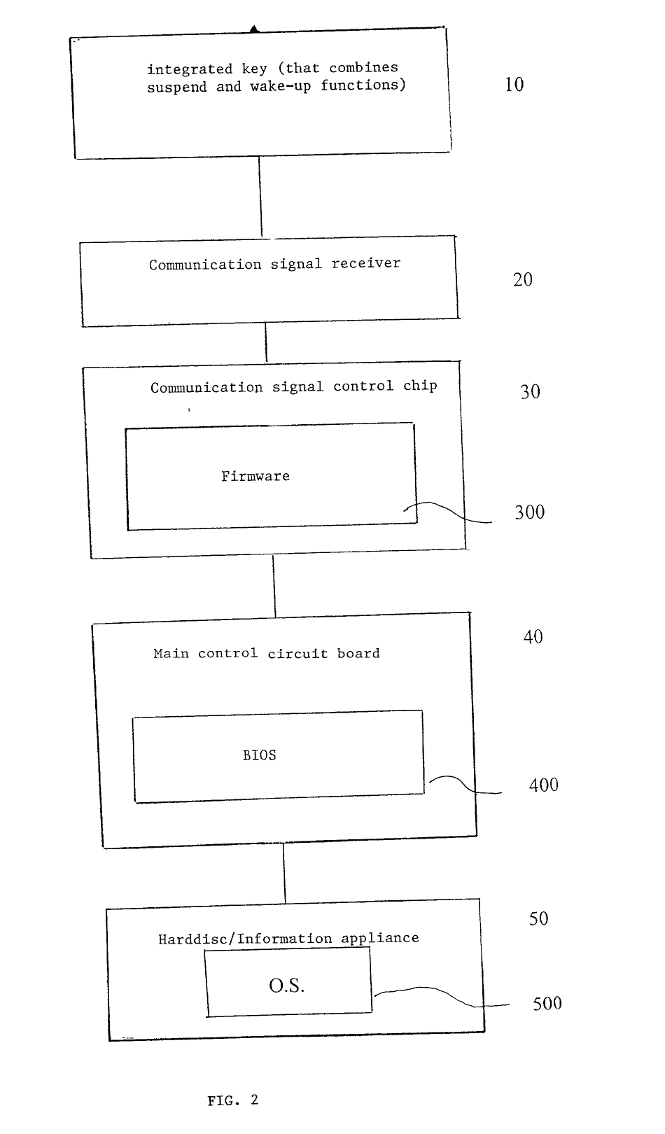

The invention is to load the known key maps into a firmware (300) on a communication signal control chip as shown in FIG. 2. All the key maps are classified into two categories: one to make a shell program judge a system under the suspend status; and the other to make the shell program judge the system under the non-suspend status.

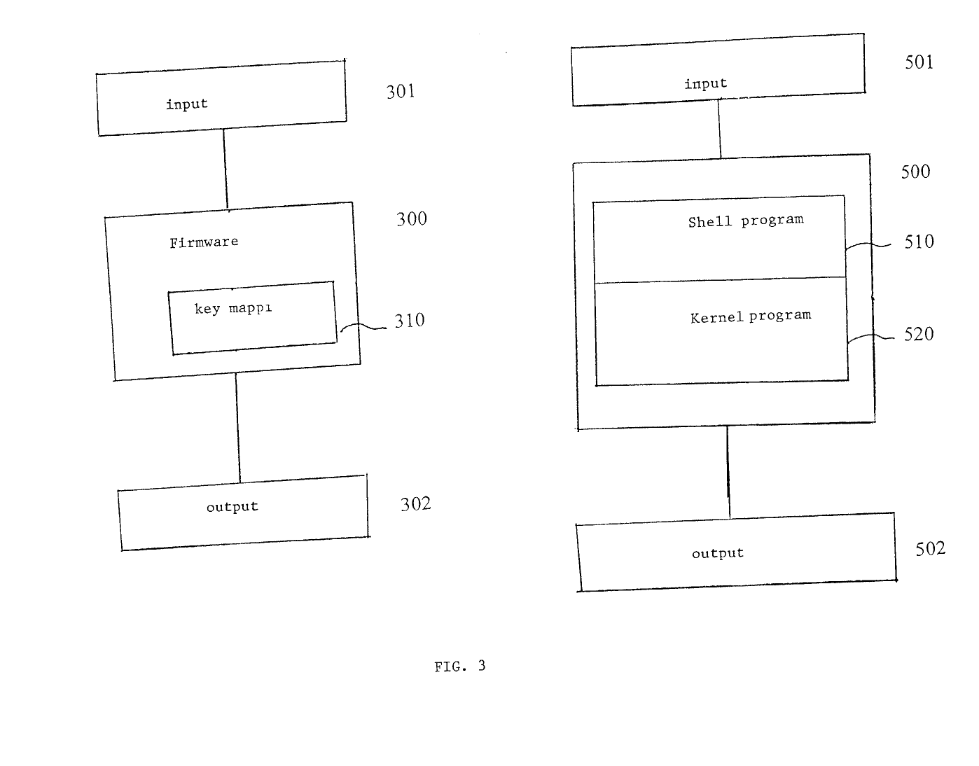

After judging the system under the suspend status a kernel program (520) of OS as shown in FIG. 3 is actuated to output a wake-up signal. Conversely, after judging the system under the non-suspend status, the kernel program of OS is actuated to output a suspend setting, and in the mean time, a communication signal receiver (20) as shown in FIG. 2 is set to only accept signals from a integrated key (10) that integrates the suspend and wake-up functions.

So the more key maps the firmware has, which correspond to different types of key layouts of a remote controller, control keyboard or panel, the more useful and changeable the controller, keyboard or panel is.

### PREFERRED EMBODIMENT

The following embodiment will provide a further explanation of the invention.

In FIG. 2, the invention applies a firmware (300) on a communication signal control chip (30) to load possible key maps for respective remote controller, remote control keyboard or panel of an IA, such that the signals received from an integrated key (10), which combines the suspend and wake-up functions, on a remote controller, remote control keyboard or panel of the IA, can be interpreted via key maps (310 in FIG. 3) stored on the firmware (300) to be recognizable to OS and thus evoke the suspend or wake-up function.

The invention is advantageous in solving the conventional problems of inconvenience, high error rate and low reliability caused by using two distinct keys for the suspend and wake-up function, respectively, thereby making the information appliance more convenient, hominized, friendly and reliable.

The invention also presents a method for forming the information appliance system having the integrated key. The method is implemented by the formation of a hardware system, a software system and the operation process thereof.

The hardware system includes an integrated key (10), which integrates the suspend and wake-up functions; a communication signal receiver (20); a communication signal control chip (30); a main control circuit board (40); and a hard disk (50).

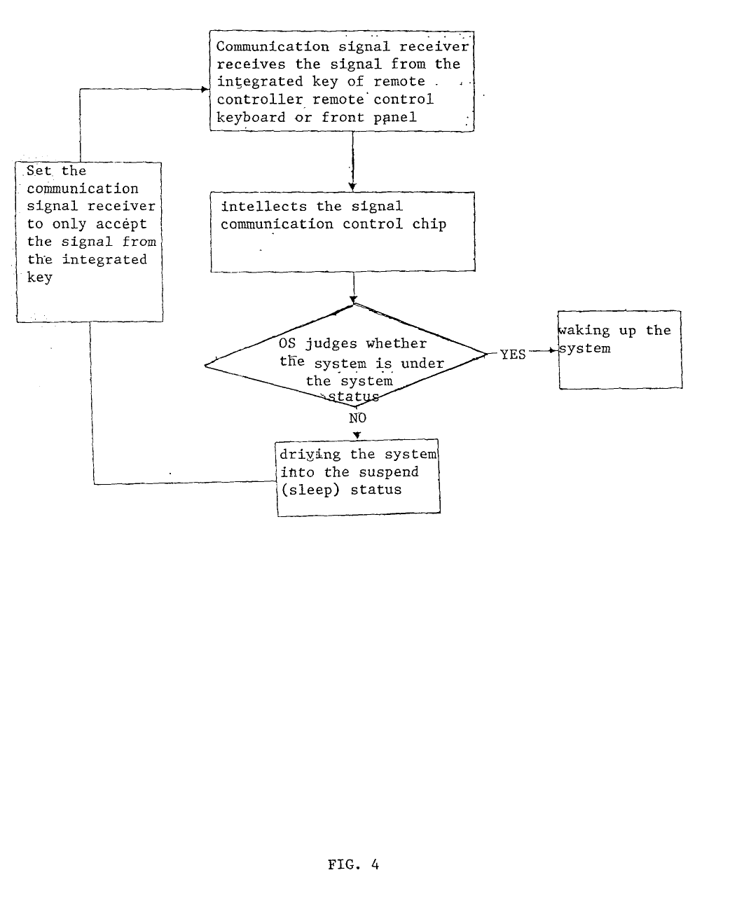

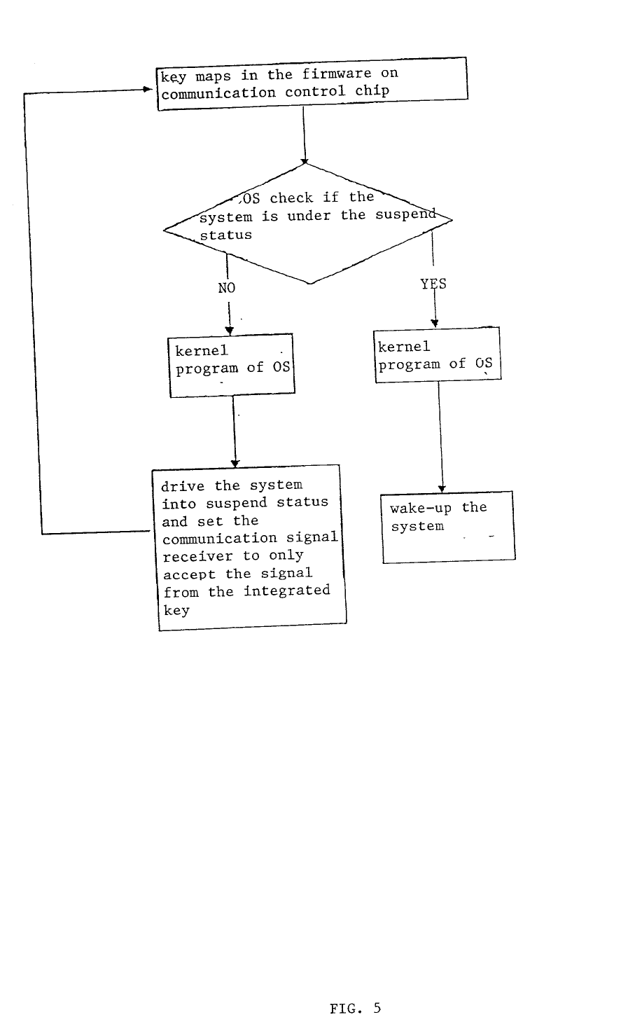

The software system comprises the firmware (300) on the communication signal control chip (30); a BIOS (400) in a main control circuit board (40); and an OS (500) in a hard disk (50). The firmware (300) has the key map (310). A shell program (510) of OS (500) includes two functions (see FIGS. 4 and 5): one is to tell a kernel program (520) to wake up the system if judging the system under the suspend (sleep) status; the other is to tell the kernel program (520) to evoke the suspend process, and set the communication signal receiver (20) to only accept signals from the integrated key (10) if judging the system under non-suspend (non-sleep) status.

The process flow of the invention is as follows:

The integrated key (10) outputs a signal via infrared, for example, to the communication signal receiver (20), which then transmits the signal to the communication signal control chip (30).

The key map (310) in the firmware (300) on the chip (30) interprets the signal and forms the output signal of chip (30). A BIOS (400) as a transmitting medium transmits the output signal as an input signal of OS (500).

After interpreting the input signal via a shell program (510) in OS (500), if judging the system under the suspend (sleep) status, then the OS tells the kernel program (520) to output a signal for waking up the system. On the other hand, if judging the system under the non-suspend status, then the OS tells the kernel program (520) to evoke the suspend program and set the communication signal receiver (20)to only accept the signal form the integrated key (10).

The invention simplifies the interpretation of OS, and integrates the suspend and wake-up into the same key to reduce the number of keys on the remote controller, remote control keyboard or panel of IA, thereby eliminating the error and shortening the down time of system due to mis-operation. Particularly, the invention is eligible for simplification of the remote controller, control keyboard or panel of IA.

While this invention has been described with reference to the above illustrative embodiments, such description is not intended to be construed in a limiting sense. Various modifications and combinations of the illustrative embodiments of the invention. will be apparent to persons skilled in the art upon reference to the description. For example, in addition to the infrared signal, the communication signal may comprise light, electric, acoustic or magnetic signal. It is therefore intended that the appended claims encompass any modification or embodiment of the invention.

1. A system for simplifying the interpretation of suspend and wake-up functions in an operating system for information appliance, said system comprising:
an input device integrating the suspend and wake-up functions into a single key;
a communication signal receiver;
a communication signal control chip, having a firmware to store key maps for said input device;
a main control circuit board containing BIOS (Basic Input/Output System) of said information appliance; and
a storage device, containing the operating system of said information appliance,
wherein according to said key maps, said operating system can judge the system under either a suspend or a non-suspend status and thus evoke a process of waking up the system or evoke a process of suspending the system and setting the communication signal receiver to accept only the signal from said input device, respectively.

2. The system of claim 1, wherein said communication signal comprises light, electric, acoustic or magnetic signal.

3. A method of simplifying the interpretation of suspend and wake-up functions in an operating system for information appliance, wherein key maps are divided into two categories: one to make the operating system to judge said information appliance under a suspend status, and the other to make the operating system to judge the information appliance under a non-suspend status, said method comprising the steps of:
via a communication signal receiver, accepting a signal from an input device, said input device integrating the suspend and wake-up functions; and
according to a corresponding key map, via the operating system, judging said information appliance under either a suspend or a non-suspend status and then evoking a process of waking up said information appliance, or evoking a process of suspending said information appliance and setting said communication signal receiver to only accept the signal from said input device.

4. An information carrier or embedded electronic product comprising the system of claim 1.

5. An information carrier or embedded electronic product comprising the system of claim 2.

6. The information carrier of claim 4, said information carrier comprising a disc, floppy disc, optical disc, memory device or any other storage device.
